(19) United States
(12) Patent Application Publication
(10) Pub. No.: US 2008/0041670 A1
(43) Pub. Date: Feb. 21, 2008

(54) WHEEL BRAKE ACTUATOR

(76) Inventors: Richard Edgar Thompson, Monmouthshire (GB); John Murdoch Robertson, Cheshire (GB); Albert Juanpere, Barcelona (ES); Richard Martin Bellingham, Wrexham (GB); Michael James Gaywood, Newport (GB); Martin Pors Taylor, Torfaen (GB); Sridhar Aprameya, West Midlands (GB); Shan Shih, Troy, MI (US); Jonathan Leslie Christopher Jackson, Herefordshire (GB)

Correspondence Address: CARLSON, GASKEY & OLDS, P.C., 400 WEST MAPLE ROAD, SUITE 350, BIRMINGHAM, MI, 48009, US

(21) Appl. No.: 11/745,013

(22) Filed: May 7, 2007

(30) Foreign Application Priority Data
May 10, 2006 (GB) 0609258.9

(51) Int. Cl. B60T 1/06

(52) U.S. Cl. 188/18 A

(57) ABSTRACT

An arcuate support for a disk brake caliper is keyed to a tubular axle casing, for example, by way of a woodruff key, to transmit braking torque. The support may slide axially of the axle casing to permit the caliper to accommodate brake pad wear. This construction eliminates the need for a moving component of the brake caliper itself. In the latter case, braking torque may be transmitted via the keyed connections or via a separate torque arm.

### REFERENCE TO RELATED APPLICATIONS

This application claims priority to United Kingdom Patent Application No. GB 0609258.9 filed on May 10, 2006.

### BACKGROUND OF THE INVENTION

This invention relates generally to wheel brakes of vehicles, and particularly to an actuator for a disc brake.

Conventionally, a disc brake includes a rotor which forms part of a wheel hub and a caliper which straddles the rotor and is grounded on a vehicle axle. Brake pads of the caliper can be urged on demand against opposite annular faces of the rotor to slow a wheel, and brake reaction torque is transmitted to the axle, and via suspension arrangements, to the vehicle body. In cars, the caliper is usually hydraulically actuated, whereas in commercial vehicles the caliper is operated by a relatively large air actuator.

Calipers which straddle the disc conventionally require mountings on a vehicle axle housing. Typically, these are provided by fixed lugs to which the caliper is attached by screws. The lugs may, for example, be integrally formed as part of a cast stub axle housing or provided by any suitable way at an end of a rigid axle. Once designed and manufactured, the relative position of the caliper is fixed with respect to the wheel and the suspension components. However, space within a wheel arch is tightly constrained, and in certain circumstances it may be desirable to locate the caliper at a different angular orientation, for example to permit fitting of different components in the wheel arch space. These methods of caliper mounting do not permit relocation without design and manufacture of a different axle housing, with the disadvantage of additional cost and plurality of components.

It has also been proposed to use an adaptor plate to vary a circumferential position of the caliper, by for example providing a ring of bolt holes around the axle. However, this adds to cost and weight, and is generally undesirable.

What is required is an alternative caliper mounting which permits variability of angular position with minimum adaptation of standard components.

### SUMMARY OF THE INVENTION

According to a first aspect of the invention, there is provided an arcuate support of a disc brake caliper of a vehicle. The support is adapted to receive an axle casing and has an abutment for non-rotational engagement with respect to the axle casing.

The axle casing may include a tubular half shaft housing of a rigid axle, or a stub axle housing of a vehicle with an independent suspension. Non-rotational is defined as restrained against any relative arcuate movement, such as by a woodruff key or a spline.

Such an arrangement avoids the usual cast or welded mounting flange on the axle casing and is suitable to locate the caliper at different arcuate positions. In one embodiment, a discontinuity, such as a key, is provided between the support and the axle casing. Non-rotational engagement ensures that braking torque generated at the caliper is grounded via the axle casing. Several key or spline positions may be provided, or alternatively one of the support and the casing can have a fixed key position, whereas the other can be machined to suit the intended arcuate location.

A conventional brake caliper typically consists of a fixed member anchored to the axle and a relatively movable member slidable thereon via, for example, slide pins. In this form of construction, the fixed member transmits braking torque to the axle, whereas the sliding member applies a clamping force to the brake pads.

In one embodiment of the invention, the support may be adapted for sliding movement along a drive axis, for example, via a keyway. This arrangement avoids the requirement for separate sliding members of the caliper assembly. Typically, the caliper includes a single member incorporating a bridge which straddles the brake rotor. The outboard pad is fixed relative to the bridge, whereas the inboard pad transmits brake torque to the bridge but is slidable in the direction of the drive axis under the action of an actuator mounted on the single member. Wear of the outboard pad is accommodated by sliding of the single member relative to the vehicle axle. Wear of the inboard pad is by adjustment of the actuator output shaft, typically via an automatic wear adjuster.

A particular advantage of the invention is that stress raisers of welded joints are avoided, and accordingly fatigue failures of the axle casing are less likely. Distortion of the casing under welding is also avoided. Furthermore, a discontinuity which transfers braking torque from the support to the axle casing can be accurately machined, and thus designed to resist fatigue failure, in contrast to a welded join, which is somewhat unpredictable. Yet another advantage over welded construction is that the materials of the support and axle casing can be optimized without regard to mutual weldability. Cast axle casings have integral flanges, but are not suitable for modification after manufacture.

In one embodiment, the support includes an annulus assembled axially over an axle end in advance of the brake rotor and the hub. A single woodruff key may be provided to restrain the support against relative rotation. The keyway can be provided at any circumferential location, for example, on the neutral bending axis and of a length and a thickness to suit the intended duty. An axle with a fixed keyway design can have different supports fitted thereon to give different angular caliper positions. Thus, a single axle design may be adapted to a variety of vehicles having different wheel arch envelopes, and thus a variety of possible caliper locations. The support and/or axle may have plural keyways to permit components to be assembled in one of a number of angular positions.

Preferably, the support fits closely to the exterior of the axle casing, for example against a cylindrical external surface. In the case of an annular support, a close sliding fit is desirable.

The support may include a portion of an annulus having sufficient circumferential extent for opposite discontinuities to prevent rotation relative to the axle casing. Thus, the support may, for example, be ‘C’ shaped. Fixed inward or outward discontinuities, in the form of fingers, may be provided and for direct location in corresponding recesses. Separate keys and the like are thereby avoided. A spline connection may be provided to give a very large number of potential support locations.

In the alternative, the abutment may include a torque reaction arm grounded directly or indirectly on the axle casing. The arm may, for example, be grounded indirectly on a suspension component, such as a trailing radius arm, or on the vehicle body/chassis. In this embodiment, a keyway may permit sliding movement of a caliper to accommodate pad wear, but is relieved of substantially all braking torque.

In one embodiment, the trailing arm may include end connections which permit arcuate movement to accommodate slight change of orientation during working of the vehicle suspension. Such connections, which may, for example, pivot parallel to the drive axis, are required only if such orientation changes are features of the selected grounding point.

A feature of many disc brake installations is the use of a single-sided caliper in which the actuating element (piston or tappet) is at the inboard side and acts directly on the inboard brake pad. The outboard brake pad is applied by a bridge which straddles the rotor and receives the reaction force of the actuating element. The bridge (or bridge assembly) is slidably mounted on a fixed member of the vehicle axle or the stub axle.

According to a second aspect of the invention, a bridge member of a disc brake caliper includes an arcuate support adapted to receive an axle casing in the arcuate support for sliding, non-rotational engagement.

Such sliding non-rotational engagement may, for example, be provided by a keyway or spline and permits the bridge member to adopt an appropriate position with respect to the rotor having regard to the brake pad wear.

Several forms of arcuate support are possible, as mentioned in connection with the first embodiment of the invention. In one embodiment, the bridge member includes an annular support adapted for close fitting assembly on a tubular end of an axle or stub axle and restrained against rotation by a suitable keyway or spline. Thus, a sliding connection can be provided at the axle rather than by a caliper mounting attached to the axle. In the case of a splined connection, a plurality of angular mounting positions are readily available.

Such a non-rotational connection may also be used to ground brake torque to the axle or grounding may be via a separate feature, such as a torque reaction arm.

### BRIEF DESCRIPTION OF THE DRAWINGS

Other features of the invention will be apparent from the following description of a preferred embodiment shown by way of example only in the accompanying drawings in which:

FIG. 1 is an isometric view of a conventional vehicle axle assembly;

FIG. 2 is a plan view of one end of the axle of FIG. 1;

FIG. 3 is an axial section through one end of an axle incorporating the present invention;

FIG. 4 is a part-sectional axial view of the embodiment of FIG. 3 from an outboard side;

FIG. 5 schematically shows an alternative arrangement for transmitting braking torque to the axle; and

FIG. 6 schematically shows an alternative arrangement for transmitting braking torque to the axle.

### DETAILED DESCRIPTION OF THE PREFERRED EMBODIMENT

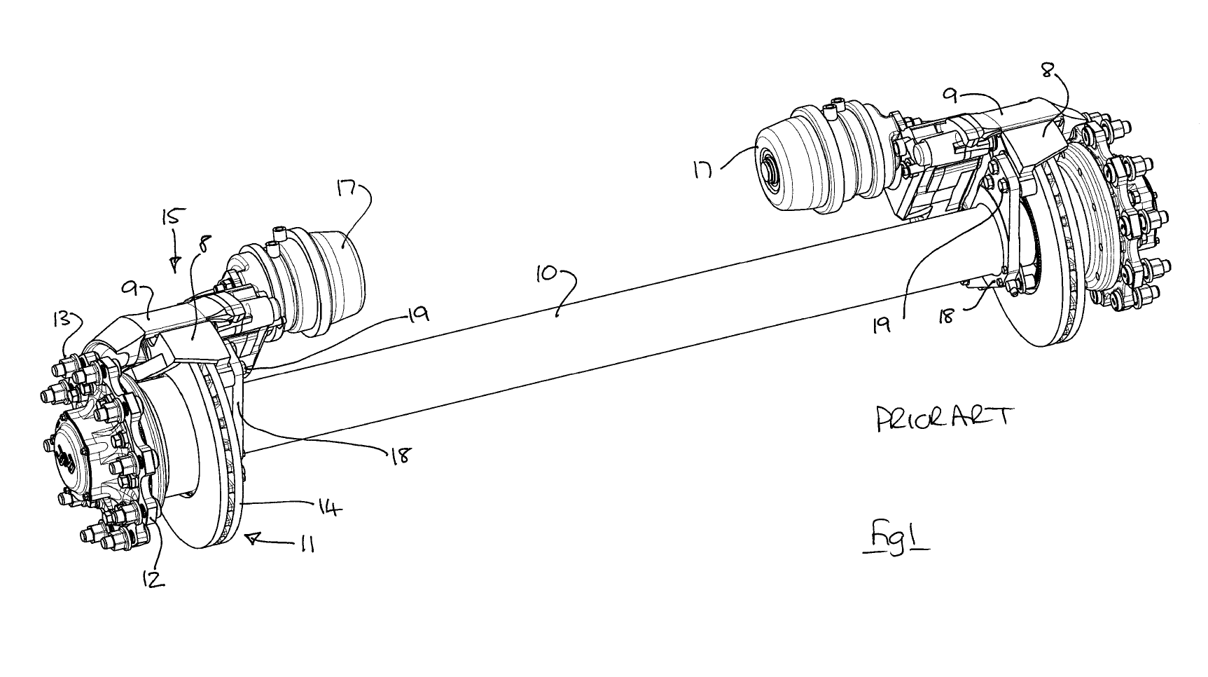

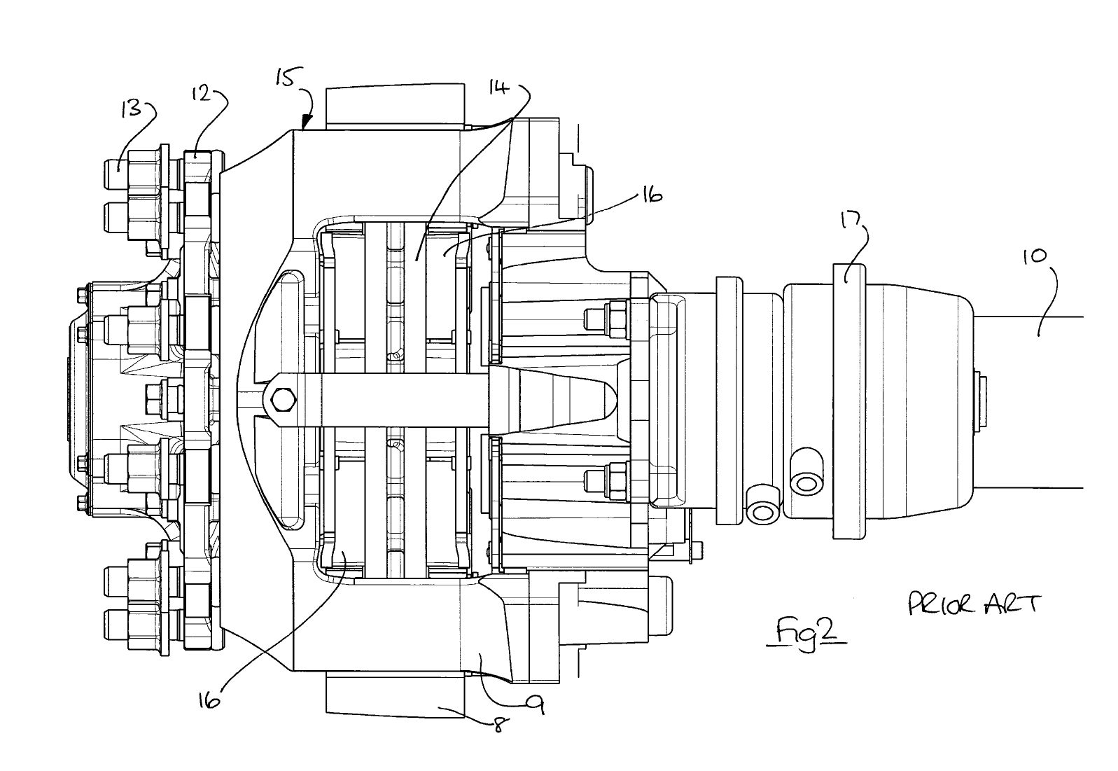

With reference to FIG. 1 and 2, a conventional axle casing 10 has at one end a rotational hub 11 having the usual flange 12 with wheel studs 13. Inboard of the rotational hub 11 and rotatable therewith is a brake rotor 14. Surmounting the brake rotor 14 is a brake caliper 15 having opposed brake pads 16 adapted to be actuated by an air actuator 17. The brake caliper 15 is grounded via an arcuate flange 18 welded to the axle casing 10 to which the brake caliper 15 is attached by bolts 19. Such an arrangement schematically represents a typical prior art caliper mounting. As an alternative, the arcuate flange 18 may form part of another component, for example a suspension mounting, or a forged axle end to which an axle tube is pinned or welded.

In the embodiment of FIGS. 1 and 2, the brake caliper 15 includes a fixed member 8 attached to the arcuate flange 18 and a sliding bridge member 9 on which the air actuator 17 is mounted. The brake pads 16 transmit braking torque directly to the fixed member 8, the air actuator 17 directly applying the inboard brake pad, whereas the outboard brake pad is applied by the sliding bridge member 9. Thus, the sliding bridge member 9 is subjected to clamping forces only.

An axle to which the arcuate flange 18 has been welded, or which has a fixed bolting position, may be unsuitable for fitting to a different kind of vehicle or a variant vehicle solely because the flange is in the wrong position with respect to the desired caliper mounting. Furthermore, a welded joint, which is most commonly used, tends to distort the relatively thin axle casing and may lead to stress raisers and fatigue cracking, neither of which is acceptable. Other difficulties of welding are that the welded join may be at an undesirable circumferential location on the axle casing 10, such as a location subject to maximum bending stresses, and that the support and casing must be of compatible weldable materials.

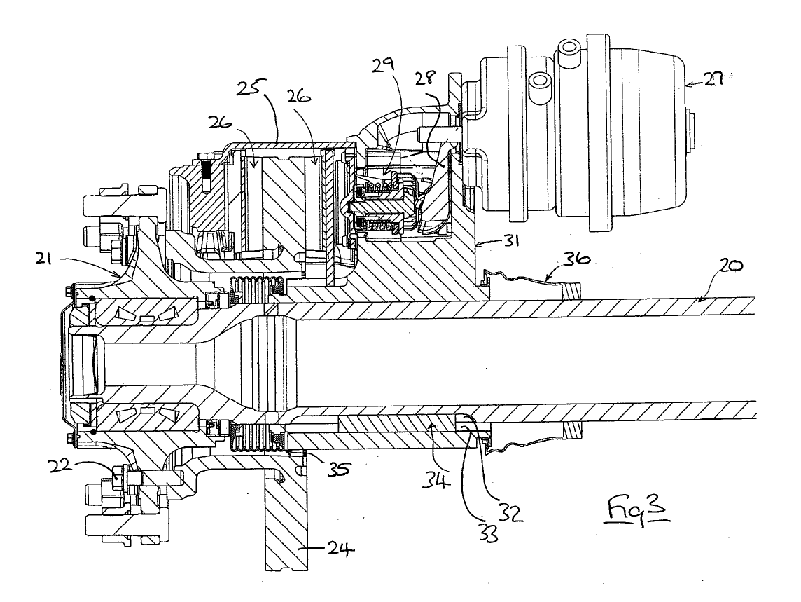

FIG. 3 illustrates an embodiment according to the invention. A tubular axle casing 20 has a rotatable hub 21 to which a brake rotor 24 is attached by bolts 22. A brake caliper 25 straddles the brake rotor 24 and has opposed brake pads 26. An air actuator 27 is operable to apply an inboard brake pad directly to the brake rotor 24 via a lever 28 and a wear adjuster 29. The outboard brake pad is applied by sliding of the brake caliper 25 to the right, as will be explained.

An annular support 31 is an integral part of the brake caliper 25 and surrounds the axle casing 20. The annular support 31 may be cast in unit, or be bolted or attached in any other suitable manner. The brake caliper 25 may be a single component or may be assembled from parts, e.g., with a bridge permanently attached by screws.

Keyways 32 and 33 are formed respectively in the axle casing 20 and the annular support 31 so that insertion of a woodruff key 34 retains the axle casing 20 and the annular support 31 against relative rotation. Thus, braking torque is grounded to the axle casing 20 via the woodruff key 34 and welded connections are avoided. Dust boots 35 and 36 prevent ingress of dirt and moisture.

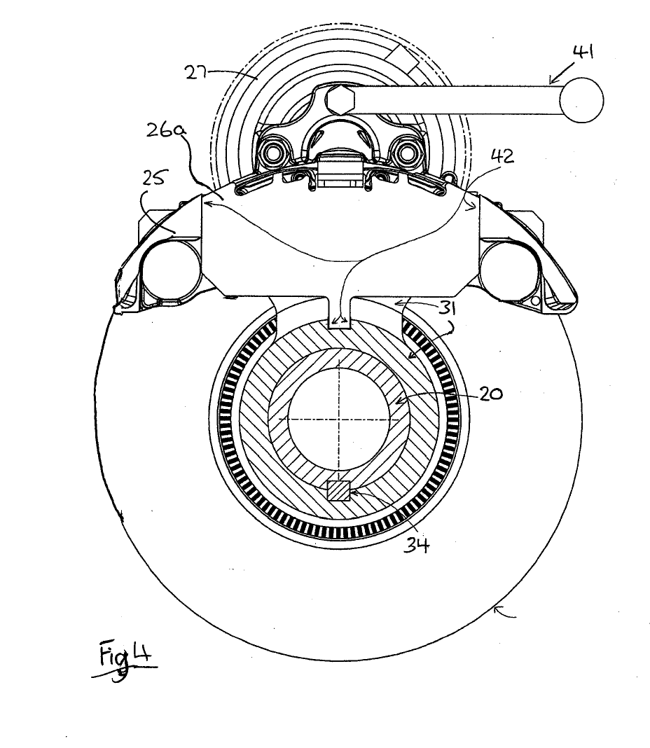

FIG. 4 corresponds to FIG. 3 and illustrates the annular support 31, the axle casing 20 and the woodruff key 34. Also shown in FIG. 4 is an alternative way of reacting braking torque via a reaction arm 41 fixed at one end with respect to the annular support 31 and to a suitable grounding element of the vehicle axle, the suspension, or the body/chassis at the other end. Abutment locations 42 of an inboard brake pad 26a are also illustrated. The reaction arm 41 may have a dual function by providing an anti-dive link for the vehicle suspension.

The invention permits selection of appropriate materials for the axle casing 20 and the annular support 31. For example, the axle casing 20 may be of thin steel tube, whereas the annular support 31 may be a cast or forged component. A brake caliper 25 is generally insensitive to angular location, and accordingly the invention provides an improved chance that a large component, such as the air actuator 27, can be accommodated in a convenient and protected location.

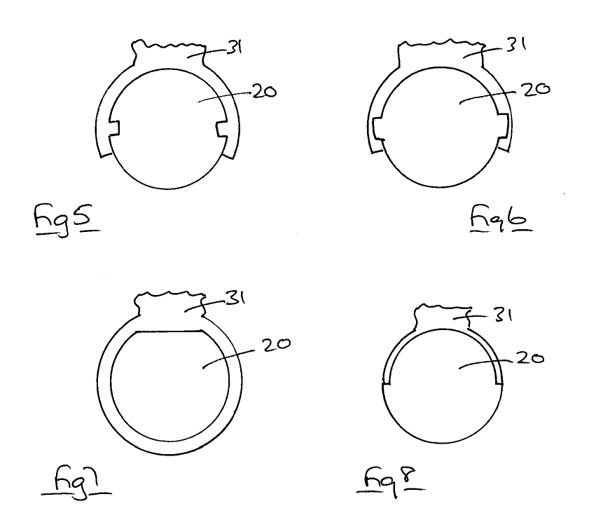

FIGS. 5-8 show some examples of other arrangement for transferring during torque from the annular support 31 to axle casings 20.

FIG. 4 illustrates an alternative aspect of the invention whereby brake torque is grounded by the reaction arm 41, and the woodruff key 34 provides a sliding connection for the brake caliper 25 to equalize pressure on the brake pads 26 and accommodate wear. In this embodiment, if the axle is cylindrical, the outer surface of the axle casing 20 can provide a sliding surface without need for the woodruff key 34. Thus, the usual sliding connection, e.g., by pins, is not provided in the caliper assembly itself, but on the axle. Thus, the invention permits the woodruff key 34 (or equivalent sliding connection) to transfer braking torque to the axle (thus eliminating the need for separate torque reaction feature, such as the reaction arm 41) or simply act as a sliding support for the brake caliper 15.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. An arcuate support of a disc brake caliper of a vehicle, wherein the arcuate support is adapted to receive an axle casing, and the arcuate support has an abutment for non-rotational engagement with the axle casing.

2. The arcuate support according to claim 1 including an annulus to receive the axle casing.

3. The arcuate support according to claim 2 wherein the annulus is centred on a drive axis of the axle casing.

4. The arcuate support according to claim 2 wherein the abutment includes a radial projection of the arcuate support.

5. The arcuate support according to claim 2 wherein the abutment includes a radial recess of the arcuate support.

6. The arcuate support according to claim 2 wherein woodruff key is included for engagement in recesses of the arcuate support and the axle casing.

7. The arcuate support according to claim 1 wherein the arcuate support receives the axle casing.

8. The arcuate support according to claim 7 wherein the arcuate support and the axle casing have an axially sliding fit.

9. The arcuate support according to claim 7 wherein the abutment includes an arm extending from the arcuate support and adapted to be fixed relative to the axle casing.

10. The arcuate support according to claim 9 wherein the arm extends perpendicular to a drive axis of the axle casino, and is adapted for articulation in a plane perpendicular to the drive axis.

11. An arcuate support of a disc brake caliper of a vehicle, the arcuate support being adapted to receive an axle casing in slidable non-rotational engagement with the arcuate support.

12. The arcuate support according to claim 2 further including one of a spline and a keyway between the arcuate support and the axle housing.
